(19) United States
(12) Patent Application Publication
(10) Pub. No.: US 2013/0031996 A1
(43) Pub. Date: Feb. 7, 2013

(54) Pin Roller Type Pinion Device

(71) Applicant: Kenji IMASE, Aichi (JP)

(72) Inventor: Kenji IMASE, Aichi (JP)

(21) Appl. No.: 13/239,551

(22) Filed: Sep. 22, 2011

(30) Foreign Application Priority Data
Aug. 4, 2011 (JP) 2011-170743

(51) Int. Cl. F16H 55/17

(52) U.S. Cl. 74/465

(57) ABSTRACT

In a pin roller type pinion device, a first bearing has first pin needles rollably arranged around pin rollers between an inner surface of first circular holes and one end portion of the pin rollers. A second bearing has second pin needles rollably arranged around the pin rollers between an inner surface of second circular holes and the other end portion of the pin rollers. This prevents an external pressure from developing on the inner surface of the circular holes when inserting the pin needles between the inner surface of the circular holes and the end portions of the pin rollers.

### BACKGROUND OF THE INVENTION

1. Field of the Invention

The present invention relates to a pin roller type pinion device in which a pinion has a plurality of pin rollers, some of which engage with a rectilinear rack, and particularly concerns to a pin roller type pinion device which has bearings to rotatably support the pin rollers.

2. Description of Related Art

A rack combined with a pinion has been known as a rack-and-pinion type steering device, a rack-and-gear device or a torque-transmission device, the latter of which is disclosed by Korean patent No. 10-0945193.

In the torque-transmission device, a plurality of pins are provided between a first disc plate and a second disc plate to constitute a pinion. The pinion is brought into engagement with a rectilinear rack so as to move along the rack in combination with the rotational movement of the pinion. This makes it possible to constitute a rack-and-pinion structure of low noise and low vibration with a least jounce and low transmission loss.

The rack-and-pinion structure has been effectively employed to the manufacturing field by incorporating it into a machine tool, precision machine, factory robot, component part stocker or washing line.

In recent years, it becomes necessary for electronic factories to transfer bundles of ultra-thin vitreous sheets for an extended distance along the rectilinear rack so that the thin vitreous sheets are applied to liquid-crystal displays for personal computers in an assembly location. In this instance, it is quintessential to structurally improve the pinion in order to maintain a smooth engagement with the rack so as to provide the pinion with a swift and low-noise rotational movement.

For this purpose, a bearing is provided between the first disc plate and one end of the pin, and another bearing is provided between the second disc plate and the other end of the pin.

As shown in FIG. 12, the bearing 49 is placed within bores 54 pierced through the first disc plate 52 at regular intervals along a basic circle (not shown). The bearing 49 has a cylindrical outer race 50 interfit into the bores 54. Along the inner surface of the outer race 50, a multitude of pin needles 51 are circumferentially arranged. Open ends of the outer race 50 form respective annular edges 50a, 50b as a retainer to hold the pin needles 51 in place as shown in FIGS. 13, 14. Into the outer race 50, inserted is the pin 56 through the pin needles 51. In FIG. 12, the bearing 49 is depicted by representing the central one among three bearings placed within the respective bores 54.

Upon securing the bearing 49 to the first disc plate 52, the outer race 50 is pressure fit into the bore 54 to locate the outer race 50 in place. Since the bores 54 are formed near an outer periphery 52a of the first disc plate 52, thus making a distance (t) short between the bore 54 and an outer peripheral surface 52b of the first disc plate 52.

For this reason, upon pressure fitting the outer race 50 into the bore 54, an inner surface of the bore 54 may be subjected to a radial force H to expand, thereby making the outer periphery 52a deform to bulge outward as shown at phantom line K in FIG. 12.

Once the outer periphery 52a is deformed, the deformation deteriorates the transmission precision between the pinion and the rack, so that the pinion loses its smooth rotational movement to induce an unacceptable level of noise upon transmitting the rotational movement to the rack.

With the transmission precision thus deteriorated, there develops wear between the pinion and the rack to reduce the load capacity which the rack bears from the pinion so as to induce a malfunction which leads to shortening the service life.

Therefore, the present invention has been made with the above drawbacks in mind, it is a main object of the invention to provide a pin roller type pinion device which is capable of preventing a first and second disc plate from being deformed when placing a first and second bearing to a first and second circular hole, and ameliorating a transmission precision to reduce an amount of wear between the pinion and the rack, thus increasing a load capacity that a rack bears from a pinion for an extended service life.

### SUMMARY OF THE INVENTION

According to the present invention, there is provide a pin roller type pinion device in which a first disc plate has a plurality of first circular holes formed along a pitch circle at regular intervals. A second disc plate is provided to face the first disc plate and having a plurality of second circular holes corresponding to the plurality of first circular holes. A plurality of pin rollers each has one end portion rotatably supported by the first circular hole by means of a first bearing, and having the other end portion rotatably supported by the second circular hole by means of a second bearing so as to constitute a pinion which engages with a rack through the pin rollers. The first bearing has a plurality of first pin needles rollably arranged around the pin rollers circumferentially between an inner surface of the first circular holes and the one end portion of the pin rollers. The second bearing has a plurality of second pin needles rollably arranged around the pin rollers circumferentially between an inner surface of the second circular holes and the other end portion of the pin rollers.

With the pin needles insertedly placed between the inner surface of the first and second circular holes and the end portions of the pin rollers, it is possible to prevent an exterior pressure from developing on the inner surface of the first and second circular holes even when the first and second circular holes are formed near the outer periphery of the first and second disc plate. This is contrary to the prior case in which the outer race is pressure fit into the circular hole.

With the exterior pressure thus prevented, it is possible to avoid the first and second disc plate from being deformed in such a direction as to budge the inner surface of the first and second circular holes of the first and second disc plate.

By avoiding the deformation subjected to the first and second disc plate, it is possible to ameliorate the transmission precision between the pinion and the rack, so that the pinion maintains its smooth rotational movement with the least level of noise and vibration upon transmitting the rotational movement to the rack or rotating along the rack in the lengthwise direction.

With the transmission precision thus ameliorated, it is possible to decrease an amount of wear between the pinion and the rack, thus increasing the load capacity which the rack bears from the pinion for an extended service life.

According to other aspect of the present invention, the first bearing has a cylindrical first inner race interfit into the one end portion of the pin rollers. The cylindrical first inner race has a plurality of grooves circumferentially at regular intervals, into which the first pin needles are rollably interfit. The second bearing has a cylindrical second inner race interfit into the other end of the pin rollers. The cylindrical second inner race has a plurality of grooves circumferentially at regular interval

s, into which the second pin needles are rollably interfit.

With the first and second pin needles rollably interfit into the first and second grooves, it is possible to favorably locate the first and second pin needles in place on the first and second inner race. This makes it ready to place the first and second bearing into the inner surface of the first and second circular holes so as to quickly assemble the first and second bearing to the first and second circular holes.

According to other aspect of the present invention, the first bearing has the plurality of first pin needles provided to circumferentially surround an outer surface of the one end portion of the pin roller, and arranged to slidably engage with the inner surface of the first circular holes. The second bearing has the plurality of second pin needles provided to circumferentially surround an outer surface of the other end portion of the pin roller, and arranged to slidably engage with the inner surface of the second circular holes.

With the plurality of the first and second pin needles provided to circumferentially surround an outer surface of the end portions of the pin roller, the first and second pin needles form an integrated needle, so that they can endure a high load which the first and second pin needles bear so as to resultantly enhance a load capacity which the first and second pin needles bear.

According to other aspect of the present invention, the inner surface of the first circular holes and the inner surface of the second circular holes are case-hardened by means of heat treatment.

With the hardened the inner surface of the first and second circular holes, it is possible to increase their wear-resistant property so as to enhance their rupture strength for an extended service life.

### BRIEF DESCRIPTION OF THE DRAWINGS

A preferred form of the present invention is illustrated in the accompanying drawings in which:

FIG. 1 is a perspective view of a rack-pinion transmission device into which a pin roller type pinion device is incorporated according to a first embodiment of the invention;

FIG. 2 is an exploded view of the pin roller type pinion device;

FIG. 3 is a perspective view of a pin roller, first inner race, second inner race, first pin needles and second pin needles;

FIG. 4 is a perspective view of the pin roller, first bearing and second bearing;

FIG. 5 is a longitudinal cross sectional view of the first bearing placed between an inner surface of the first circular hole and one end portion of the pin roller;

FIG. 6 is a longitudinal cross sectional view showing the second bearing placed between an inner surface of the second circular hole and the other end portion of the pin roller;

FIG. 7 is a latitudinal cross sectional view taken along the line S-S of FIG. 6;

FIG. 8 is a longitudinal cross sectional view of the first bearing placed between the inner surface of the first circular hole and one end portion of the pin roller according to a second embodiment of the invention;

FIG. 9 is a perspective view of a retainer, first pin needles and one end portion of pin roller;

FIG. 10 is a perspective view of the first bearing placed in the inner surface of the first circular hole according to a third embodiment of the invention;

FIG. 11 is a perspective view of the first pin needles annularly placed around one end portion of the pin roller;

FIG. 12 is a longitudinal cross sectional view of a prior bearing placed in a cylindrical outer race interfit into the bore of a first disc plate;

FIG. 13 is a perspective view of the prior cylindrical outer race; and

FIG. 14 is a longitudinal cross sectional view taken along the line J-J of FIG. 12.

### DETAILED DESCRIPTION OF PREFERRED EMBODIMENTS

In the following description of the depicted embodiments, the same reference numerals are used for features of the same type. Positions and directions of the various members are used to correspond to right-left sides, and up-down sides of the attached drawings throughout each embodiment of the invention.

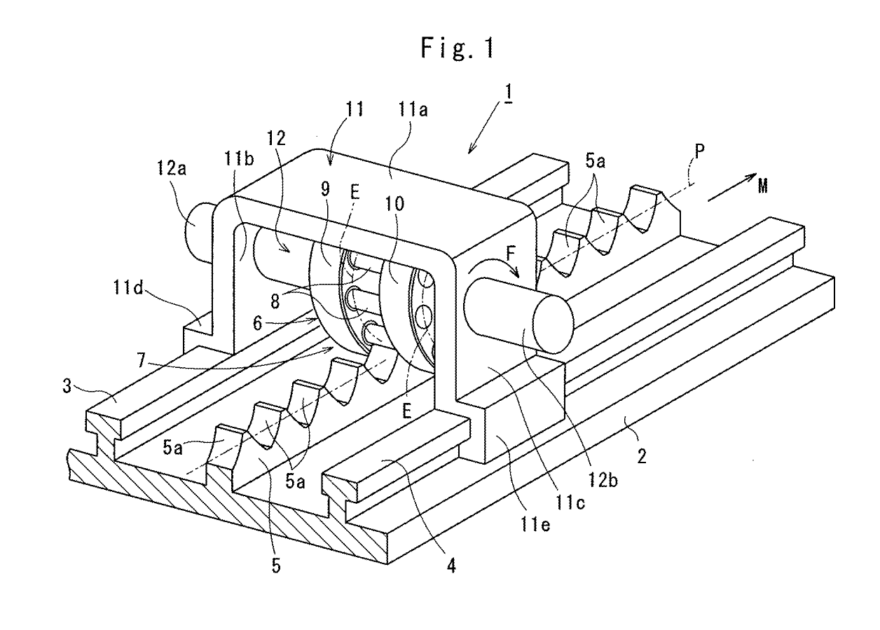

Referring to FIGS. 1 through 7 which show a pin roller type pinion device 7 according to a first embodiment of the invention, as shown in FIG. 1, a rack-pinion device 1 has a basal plate 2 placed on a ground floor (not shown) in an assembly factory by way of example.

At a right and left side of the basal plate 2, there is provided conveyance rails 3, 4 each having a T-shaped cross section. At a middle portion of the basal plate 2 between the conveyance rails 3, 4, a rectilinear rack 5 is provided along its lengthwise direction M.

A length of the rack 5 is determined to meet an object to be used, and the upper surface of the rack 5 has multitude of teeth 5a defined based on a cycloid-curved profile continuously along a pitch line P.

The pin roller type pinion device 7 has a pinion 6 having a plurality of pin rollers 8, some of which engage with the teeth 5a of the rack 5, so that the pinion 6 rotates to run along the rack 5. By way of example, the number of the pin rollers 8 is ten with the pin rollers 8 interposed between two opposed disc plates 9, 10. The pin rollers 8 are placed circumferentially along a pitch circle E at regular intervals (e.g., 36 degrees) in a fashion to constitute the pinion 6 as an annular configuration.

A gate-shaped housing 11 is provided which has a ceiling plate 11a and side walls 11b, 11c formed in turn at the right end and left end of the ceiling plate 11a so as to accommodate the pinion 6.

The ceiling plate 11a positions to cover an upper peripheral surface of the pinion 6, while the side walls 11b, 11c are located at the right side and left side of the rack 5 in a fashion to interpose the rack 5 therebetween.

At basal sections of the corresponding side walls 11b, 11c, angular walls 11d, 11e are provided symmetrically in a fashion to interpose the rack 5 therebetween. On the angular wall 11d, the conveyance rail 3 is slidably mounted, and the other conveyance rail 4 is slidably mounted on the other angular wall 11e.

A drive shaft 12 is fixedly secured to a central portion of the pinion 6. One end 12a of the on drive shaft 12 is rotatably mounted on the side wall 11b, and the other end 12b of the drive shaft 12 is rotatably mounted on the other side wall 11c.

To the drive shaft 12, connected is a rotary shaft of an electric motor (each not shown) which is placed on the housing 11. Upon energizing the electric motor, the motor transmits the rotational movement to the pinion 6 through the drive shaft 12 in the clockwise direction as designated at an arrow F in FIG. 1. Then, the pinion 6 rotates with the pin rollers 8 engaged with teeth 5a of the rack 5, so that the housing 11 slides through the angular walls 11d, 11e along the conveyance rails 3, 4 in the lengthwise direction M.

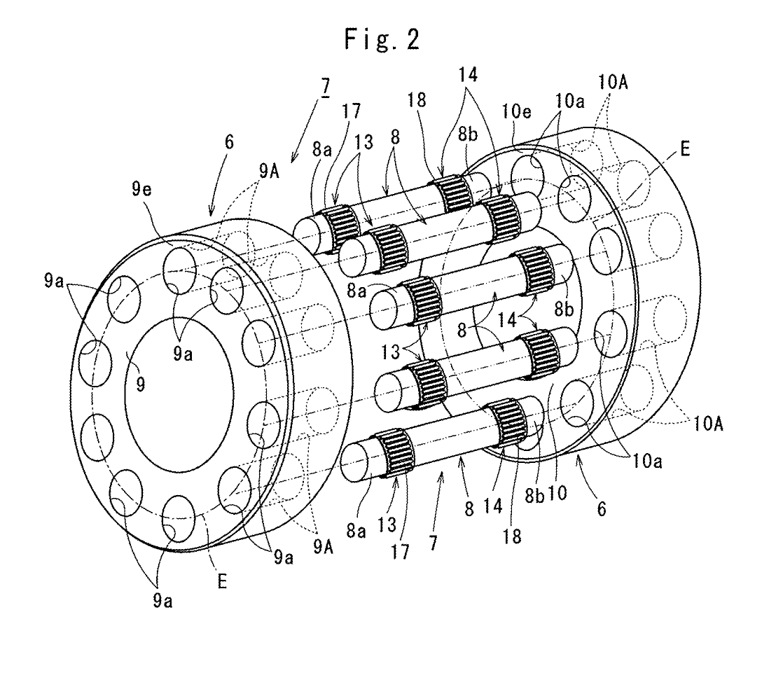

As shown in FIG. 2, the first disc plate 9 has a plurality of first circular holes 9a along a pitch circle E at regular intervals, which is defined near an outer periphery 9e of the first disc plate 9 and has the number corresponding to the number of the pin rollers 8.

The second disc plate 10 is located to face the first disc plate 9 in parallel with each other, and having second circular holes 10a corresponding to the first circular holes 9a. The second disc plate 10 has an outer periphery 10e corresponding to the outer periphery 9e of the first disc plate 9.

One end portion 8a of the pin roller 8 is rotatably supported by the inner surface 9A of the first circular holes 9a by means of a first bearing 13, and the other end portion 8b of the pin roller 8 is rotatably supported by the inner surface 10A of the second circular hole 10a by means of a second bearing 14. In order to strengthen the mechanical property, the inner surfaces 9A, 10A of the first and second circular holes 9a, 10a are case-hardened by means of heat treatment (e.g., quenching procedure).

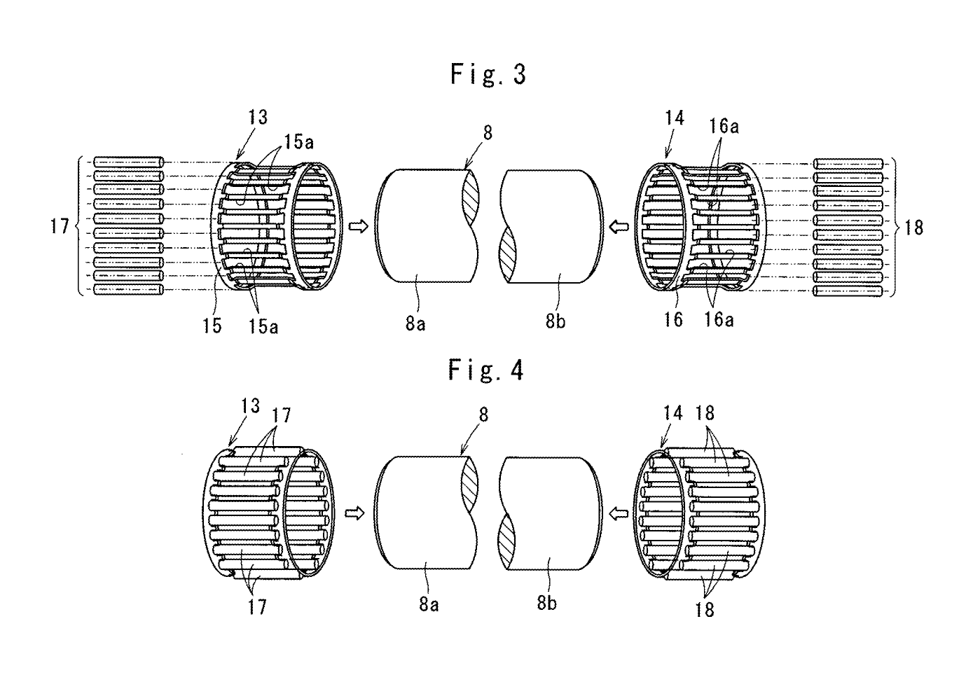

As shown in FIG. 3, the first bearing 13 has a cylindrical first inner race 15 secured to one end portion 8a of the pin roller 8. A plurality of first grooves 15a are formed circumferentially on the first inner race 15 at regular intervals. The first grooves 15a are elongated to orient along an axial direction of the first inner race 15. The number of the first grooves 15a is counted as 18-20 by way of example. First pin needles 17 are provided to be rollably located in the corresponding first grooves 15a as shown in FIG. 4.

On the other hand, the second bearing 14 has a cylindrical second inner race 16 secured to the other end portion 8b of the pin roller 8. A plurality of second grooves 16a are formed circumferentially on the second inner race 16 at regular intervals. The second grooves 16a are elongated to orient along an axial direction of the second inner race 16. The number of the second grooves 16a corresponds to the number of the first grooves 15a. Second pin needles 18 are provided to be rollably located in the corresponding second grooves 16a.

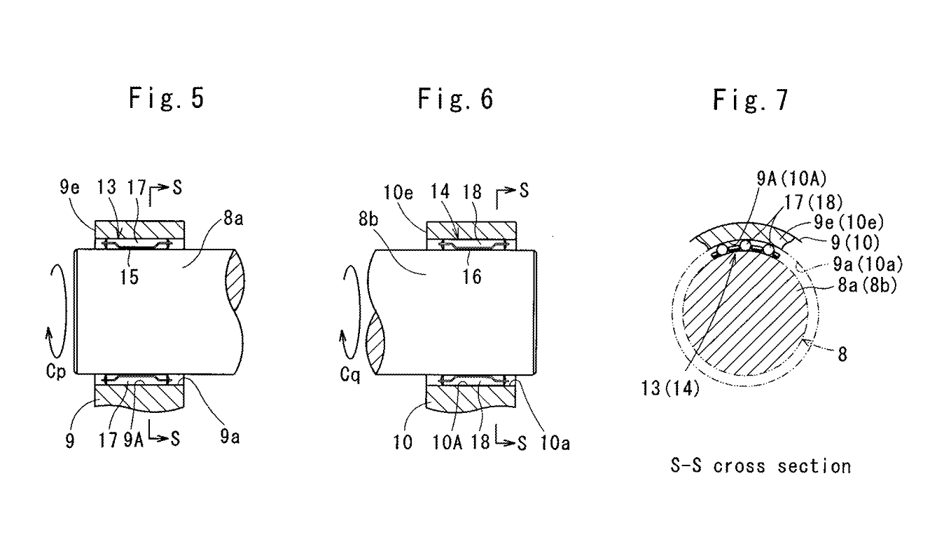

As shown in FIG. 5, the first bearing 13 is placed within the inner surface 9A of the first circular hole 9a together with the first inner race 15.

In this situation, the first pin needles 17 are insertedly arranged along the axial direction between one end portion 8a of the pin roller 8 and the inner surface 9A of the first circular hole 9a, so that the first pin needles 17 can roll along a circumferential direction Cp of the pin roller 8.

As shown in FIG. 6, the second bearing 14 is placed within the inner surface 10A of the second circular hole 10a together with the second inner race 16.

In this situation, the second pin needles 18 are insertedly arranged along the axial direction between the other end portion 8b of the pin roller 8 and the inner surface 10A of the first circular hole 10a, so that the second pin needles 18 can roll along a circumferential direction Cq of the pin roller 8.

With the structure thus described, the energized motor transmits the rotational movement to the pinion 6 through the drive shaft 12 in the clockwise direction F. The pinion 6 rotates with the pin rollers 8 engaged with teeth 5a of the rack 5, so that the housing 11 slides through the angular walls 11d, 11e along the conveyance rails 3, 4 in the lengthwise direction M. This makes it possible to transfer the bundles of the ultra-thin vitreous sheets (not shown) from a material deposit to an assembly location in order to apply the vitreous sheets to the liquid-crystal displays after placing the vitreous sheets on a pallet (not shown) secured to the housing 11.

In this instance, with the first and second pin needles 17, 18 insertedly placed between the inner surface 9A, 10A of the first and second circular holes 9a, 10a and the end portions 8a, 8b of the pin rollers 8, it is possible to prevent an exterior pressure from developing on the inner surfaces 9A, 10A of the first and second circular hole 9a, 10a even when the first and second circular holes 9a, 10a are formed near the outer peripheries 9e, 10e of the first and second disc plates 9, 10. This is contrary to the prior case in which the outer race is pressure fit into the circular hole.

With the exterior pressure thus prevented, it is possible to avoid the first and second disc plates 9, 10 from being deformed in such a direction as to budge the inner surfaces 9A, 10A of the first and second circular holes 9a, 10a of the first and second disc plates 9, 10.

By avoiding the deformation subjected to the first and second disc plates 9, 10, it is possible to ameliorate the transmission precision between the pinion 6 and the rack 5, so that the pinion 6 maintains its smooth rotational movement with the least level of noise and vibration upon transmitting the rotational movement to the rack 5 or rotating along the rack 5 in the lengthwise direction M.

With the transmission precision thus ameliorated, it is possible to decrease an amount of wear between the pinion 6 and the rack 5, thus increasing the load capacity which the rack 5 bears from the pinion 6 for an extended service life.

With the first and second pin needles 17, 18 rollably interfit into the first and second grooves 15a, 16a, it is possible to favorably locate the first and second pin needles 17, 18 in place on the first and second inner races 15, 16. This makes it ready to place the first and second bearings 13, 14 into the inner surfaces 9A, 10A of the first and second circular holes 9a, 10a so as to quickly assemble the first and second bearings 13, 14 to the inner surfaces 9A, 10A of the first and second circular holes 9a, 10a.

With the employment of the heat treatment to harden the inner surfaces 9A, 10A of the first and second circular holes 9a, 10a, it is possible to increase their wear-resistant property so as to enhance their rupture strength for an extended service life.

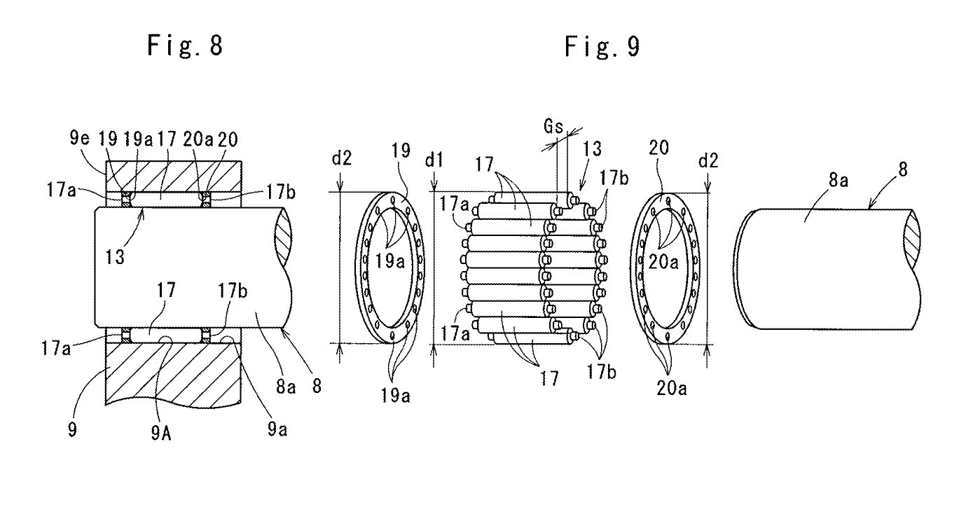

FIGS. 8 and 9 show a second embodiment of the invention in which annular first and second retainers 19, are used instead of the first and second inner races 15, 16.

As shown in FIG. 9, each of the first pin needles 17 has one end extended to have a jutted portion 17a, and having the other end extended to have a protruded portion 17b. The first retainer 19 has perforations 19a defined circumferentially, and the second retainer 10 has openings 20a arranged circumferentially.

As shown in FIG. 8, the jutted portions 17a are interfit into the corresponding perforations 19a of the first retainer 19, and the protruded portions 17b are interfit into the corresponding openings 20a of the second retainer 20, so that an array of the first pin needles 17 is annularly kept around one end portion 8a of the pin roller 8 as to define the first bearing 13. Between the neighboring first pin needles 17, there is provided a slight clearance Gs so that the first pin needles 17 are rollably arranged. The array of the first pin needles 17 has an outside diameter (d1) somewhat greater that an outside diameter (d2) of the first and second retainers 19, 20.

It is to be noted that since the second pin needles 18 have the same structure as the first pin needles 17, the relevant description is omitted in connection with the second bearing 14 and second pin needles 18. The same is true with a third embodiment of the invention.

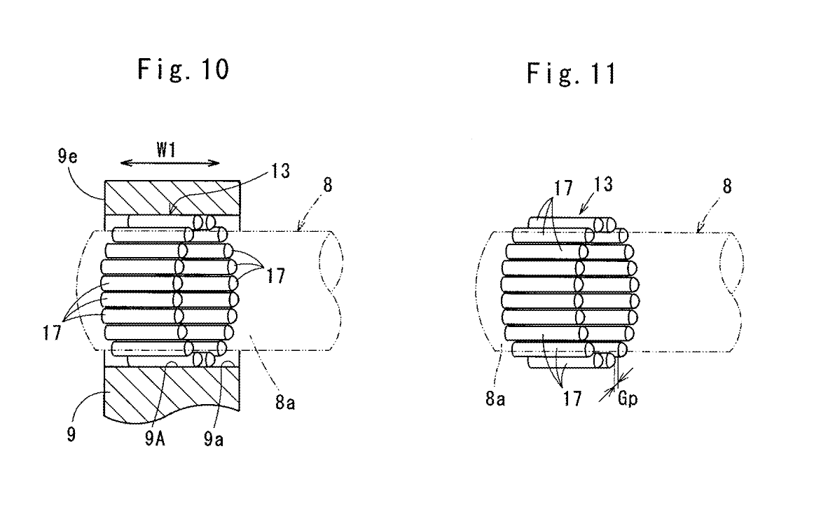

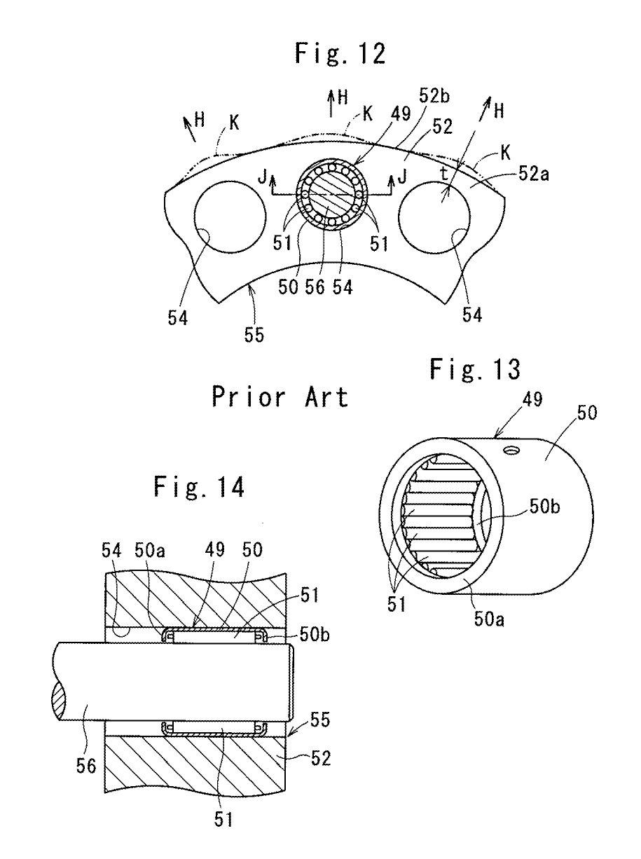

FIGS. 10 and 11 show a third embodiment of the invention which omits the first and second retainers 19, 20 of the second embodiment of the invention.

As shown in FIG. 11, the first pin needles 17 are annularly arranged around one end portion 8a of the pin roller 8 so as to form an integrated needle. Between the neighboring first pin needles 17, there is provided a slight gap Gp in order to be rollably arranged. The viscous lubrication oil such as e.g., grease (not shown) is applied to the first pin needles 17 and the one end portion 8a of the pin roller 8 so as to locate the first pin needles 17 in place.

In this situation, the grease connectedly arranges the first pin needles 17 circularly to form the first bearing 13a into a cage-shaped configuration.

With the plurality of the first pin needles 17 provided to circumferentially surround an outer surface of one end portion 8a of the pin roller 8 as shown in FIG. 10, the first pin needles 17 form the integrated needle, so that they can endure a high load which the first pin needles 17 bear so as to resultantly enhance a load capacity which the first pin needles 17 bear.

It is to be noted that a cap may be interfit into the right and left side of the inner surface 9A of the circular hole 9a to regulate the first pin needle 17 from inadvertently jogging in an axial direction W1.

### Modification Forms

(a) Instead of rotating the pinion 6 along the rack 5, the basal plate 2 may be slidable arranged against the ground surface, and the housing 11 may be fixedly secured to the ground surface together with the pinion 6 so as to move the rack 5 and the basal plate 2 in the lengthwise direction M.
(b) It is to be appreciated in the second embodiment of the invention that the first pin needles 17 may be tightly arranged to obviate the clearance Gs between the neighboring first pin needles 17.
(c) The number of the first and second circular holes 9a, 10a may be altered to be five-nine or eleven-fifteen instead of ten depending on the surrounded situation or circumstances.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

What is claimed is:

1. A pin roller type pinion device comprising:
a first disc plate having a plurality of first circular holes formed along a pitch circle at regular interval s;
a second disc plate provided to face said first disc plate and having a plurality of second circular holes corresponding to said plurality of first circular holes;
a plurality of pin rollers each having one end portion rotatably supported by said first circular hole by means of a first bearing, and said pin rollers each having the other end portion rotatably supported by said second circular hole by means of a second bearing so as to constitute a pinion which engages with a rack through said pin rollers;
said first bearing having a plurality of first pin needles rollably arranged around said pin rollers circumferentially between an inner surface of said first circular holes and said one end portion of said pin rollers; and
said second bearing having a plurality of second pin needles rollably arranged around said pin rollers circumferentially between an inner surface of said second circular holes and said other end portion of said pin rollers.

2. The pin roller type pinion device according to claim 1, wherein said first bearing comprising;
a cylindrical first inner race interfit into said one end portion of said pin rollers, said cylindrical first inner race having a plurality of grooves circumferentially at regular intervals, into which said first pin needles are rollably interfit; and
said second bearing comprising;
a cylindrical second inner race interfit into said other end of said pin rollers, said cylindrical second inner race having a plurality of grooves circumferentially at regular intervals, into which said second pin needles are rollably interfit.

3. The pin roller type pinion device according to claim 1, wherein said first bearing comprising;
said plurality of first pin needles provided to circumferentially surround an outer surface of said one end portion of said pin roller, and arranged to slidably engage with said inner surface of said first circular holes; and
said second bearing comprising;
said plurality of second pin needles provided to circumferentially surround an outer surface of said other end portion of said pin roller, and arranged to slidably engage with said inner surface of said second circular holes.

4. The pin roller type pinion device according to claim 1, wherein said inner surface of said first circular holes and said inner surface of said second circular holes are case-hardened by means of heat treatment.
